(19) United States
(12) Patent Application Publication
(10) Pub. No.: US 2024/0026709 A1
(43) Pub. Date: Jan. 25, 2024

(54) Door Opener and Occupancy Indicator

(71) Applicant: Belwith Products, LLC, Grandville, MI (US)

(72) Inventors: Michael Cohen, Buffalo Grove, IL (US); David Warmenhoven, Grandville, MI (US); Jason Arends, Buffalo Grove, IL (US); David Hilbish, Chicago, IL (US); John Veleris, Grandville, MI (US)

(21) Appl. No.: 18/223,608

(22) Filed: Jul. 19, 2023

Related U.S. Application Data
(60) Provisional application No. 63/390,892, filed on Jul. 20, 2022.
(60) Provisional application No. 63/390,908, filed on Jul. 20, 2022.

(51) Int. Cl. E05B 53/00; E05B 41/00; E05B 47/00

(52) U.S. Cl. CPC E05B 53/001; E05B 41/00; E05B 47/0001

(57) ABSTRACT

Aspects of the disclosures allow for a touchless or hands-free closing, opening, and holding (in a closed state) of a door system, including, but not limited to doors for stalls in public restrooms. Embodiments of the door opening system may include touchless mechanisms and methods that utilize various mechanical, electromechanical, and/or electronic systems and components. Aspects of the disclosures also allow for occupancy indication for a door system, including, but not limited to doors for stalls in public restrooms. Embodiments of the occupancy indication system may include an occupancy indicator that may be pushed away from a door panel to indicate whether the bathroom stall is occupied or not occupied.

### CROSS-REFERENCE TO RELATED APPLICATIONS

This application is a non-provisional of, and claims priority to, U.S. Provisional Application No. 63/390,892, filed on Jul. 20, 2022, and U.S. Provisional Application No. 63/390,908, filed on Jul. 20, 2022, which are hereby incorporated by reference herein in their entirety.

### TECHNICAL FIELD OF INVENTION

The present invention is generally related to door opening and more specifically to systems for hands-free or touchless mechanisms and methods for opening a door. The present invention is also generally related to occupancy indicators for a stall.

### BACKGROUND

The current and conventional door operators function and work by the attachment of an overhead pneumatic or hydraulic cylinder/mechanism that mounts to the top of the door and the adjoining wall or pilaster. This installation may result in a unit that is bulky, cumbersome, expensive, and lacks the ability to be mounted in tight and lightweight applications. The current system also lacks the ability to access in an emergency and lacks the ease of installation.

Additionally, current doors for commercial restroom facility stalls may include one or more problems. First, in order to close/lock/unlock the stall door, the user must perform manual tasks that require touching various types of door hardware such as slide locks, knobs, or locking mechanisms of various types. Second, the current door operations can be difficult for restroom users to visually detect whether a stall is in use (occupied) or not when the user enters the restroom. Additionally, the current door operations can be difficult to know which stall are available for use (unoccupied) before the user enters the restroom.

### SUMMARY OF THE INVENTION

Apparatus, devices, systems, and methods, for hands-free or touchless door opening in accordance with embodiments of the invention are disclosed.

In one embodiment, a device for opening of a door panel may comprise: a bracket mounted to a door frame; a rail slidably mounted to the bracket that slides along the bracket in a vertical direction; and a latch mounted on the door panel. The latch may be biased towards the door frame. When the door panel is in a closed position, the latch may engage and may be held in place by a notch in the rail. When the rail is slidably moved in the vertical direction, an opening on the rail adjacent the notch may align with and release the latch, thereby causing the door panel to swing open toward an open position.

In one or more embodiments, the device for opening of a door panel may include a release actuator connected to the rail to slidably move the rail in the vertical direction. The release actuator may be one of a motion sensor or a push button. The release actuator may electromechanically slide and move the rail in the vertical direction. The release actuator may include a foot pedal attached to the rail, wherein when a user lifts up on the foot pedal, the rail is slidably moved in the vertical direction.

In one or more embodiments, the opening on the rail may be below the notch.

In one or more embodiments, the rail may include a plurality of rail portions comprising a first rail portion and a second rail portion that includes the notch. At least a portion of the second rail portion may be constructed of a relatively more durable material than the first rail portion.

In one or more embodiments, the rail mounted to the bracket may define a vertical channel between the rail and the bracket.

In one or more embodiments, the door frame may include a pilaster and the bracket is mounted to the pilaster of the door frame.

In one or more embodiments, a magnet may provide a biasing force against the door panel toward the open position when the latch is released from the notch in the rail.

In one or more embodiments, the device for opening of a door panel may include a wireless communication module electrically connected to a sensor on the door panel. The wireless communication module may transmit a current status of the door panel.

In one or more embodiments, the device for opening of a door panel may include an occupancy indicator that provides a visual indication that the door panel is in the closed position. The occupancy indicator may be wedge-shaped and include an exterior portion and an interior portion opposite the exterior portion. When the door panel is in the open position, the exterior portion may be flush with an exterior of the bracket and the interior portion extends from an interior of the bracket. When the door panel is moved to the closed position, the door panel may push against the interior portion of the occupancy indicator, thereby pivotably rotating the occupancy indicator such that the exterior portion moves from flush with the exterior of the bracket to extending from the exterior of the bracket and providing the visual indication that the door panel is in the closed position. The occupancy indicator may include a kicker spring that is biased to push the door panel toward the open position when the latch is released from the notch in the rail. The occupancy indicator may include at least one of a red light and a green light to provide the visual indication that the door panel is in the closed position.

In another embodiment, a kit for retro-fit installation for door opening on a door panel may comprise: a bracket configured to be mounted to a door frame adjacent a door panel; a rail configured to be slidably mounted to the bracket and configured to slide along the bracket in a vertical direction; a latch configured to be mounted on the door panel; and a release actuator connected to the rail and configured to slidably move the rail in the vertical direction. The rail including a catch assembly may be located within the rail. The catch assembly may include a notch and an opening aligned adjacent the notch on the rail. The latch may include a bolt biased towards the notch and may be configured to engage with and be held in place by the notch on the catch assembly when the door panel is in a closed position. Further, the release actuator may include a foot pedal attached to a bottom portion of the rail and configured to slidably move the rail in the vertical direction when a user lifts up on the foot pedal thereby causing the opening in the catch assembly to align with and release the bolt to allow the door panel to swing open and move toward an open position.

In one embodiment, an occupancy indicator device for a door panel of a bathroom stall, the device may comprise an occupancy indicator located on a door frame of the bathroom stall. The occupancy indicator may include a first portion on an internal side of the bathroom stall, and a second portion opposite the first portion and on an external side of the bathroom stall. The first portion may be configured to engage the door panel when the door panel is in a closed position. When the first portion of the occupancy indicator is engaged with the door panel and the door panel is in the closed position, the second portion may provide a visual indication that the door panel is in the closed position.

In one or more embodiments, the occupancy indicator may pivotably rotate between an extended position and a retracted position on the external side of the bathroom stall. The extended position may provide the visual indication that the door panel is in the closed position.

In one or more embodiments, the occupancy indicator may be press-fit into a receptacle on the door frame.

In one or more embodiments, the first portion may include a paddle located on a first end of the occupancy indicator and the second portion may include an occupancy indicator flag located on a second end opposite the first end. The occupancy indicator may also include a pivot pin located between the paddle and the occupancy indicator flag. The occupancy indicator may be a wedge-shaped indicator. The occupancy indicator device may further include an inner bracket and an outer bracket engaged with the inner bracket. The inner bracket and the outer bracket may encase the wedge-shaped indicator. The inner bracket may include one or more tabs that respectively cooperate and engage with one or more slots on the outer bracket. The occupancy indicator device may further include a pivot pin located within one or more pivot slots located in one of the inner bracket or the outer bracket. The occupancy indicator may be configured to pivotably rotate about the pivot pin between an extended position and a retracted position on the external side of the bathroom stall.

In one or more embodiments, when the door panel is in an open position, the second portion may be flush with an exterior of the door frame and the first portion may extend from an interior of the door frame. When the door panel is moved to the closed position, the door panel may push against the interior portion of the occupancy indicator, thereby pivotably rotating the occupancy indicator such that the second portion moves from flush with the exterior of the door frame to extending from the exterior of the door frame and providing the visual indication that the door panel is in the closed position.

In one or more embodiments, the occupancy indicator may be weighted to keep the occupancy indicator flush with an external side of the door frame when the door is not in the closed position.

In one or more embodiments, the occupancy indicator may include a kicker spring that is biased to push the door panel toward an open position when the door panel is opened.

In one or more embodiments, the occupancy indicator may include at least one of a red light and a green light to provide the visual indication that the door panel is in the closed position.

In one or more embodiments, the door frame of the bathroom stall may comprise a pilaster, and the occupancy indicator is located on the pilaster of the door frame.

In one or more embodiments, a bracket may be mounted to the door frame of the bathroom stall and the occupancy indicator may be located on the bracket mounted to the door frame.

In another embodiment, a kit for retro-fit installation for occupancy indication for a door panel of a bathroom stall, the kit may comprise an occupancy indicator configured to be mounted on a door frame of the bathroom stall. The occupancy indicator may include a first portion configured to be mounted on an internal side of the bathroom stall, and a second portion opposite the first portion and configured to be mounted on an external side of the bathroom stall. The first portion may be configured to engage the door panel when the door panel is in a closed position. When the first portion of the occupancy indicator is engaged with the door panel and the door panel is in the closed position, the second portion may provide a visual indication that the door panel is in the closed position.

Other objects, advantages and novel features, and further scope of applicability of the present invention can be set forth in part in the detailed description to follow, and in part can become apparent to those skilled in the art upon examination of the following, or can be learned by practice of the invention. The objects and advantages of the invention can be realized and attained by means of the instrumentalities and combinations particularly pointed out in the claims.

### BRIEF DESCRIPTION OF THE DRAWINGS

The description can be more fully understood with reference to the following figures, which are presented as exemplary embodiments of the invention and should not be construed as a complete recitation of the scope of the invention, wherein:

FIG. 1A provides a front, perspective view of a door opening system in accordance with some examples of this technology;

FIG. 1B provides a component view of a housing of the door opening system from FIG. 1A in accordance with some examples of this technology;

FIG. 1C provides a cross sectional view taken along section line A-A in FIG. 1B of the housing in accordance with some examples of this technology;

FIG. 2A provides a front, perspective view of another housing of a door opening system in accordance with some examples of this technology;

FIG. 2B provides a cross sectional view of the housing of the door opening system from FIG. 2A in accordance with some examples of this technology;

FIG. 3A provides a front, perspective view of a portion of a bracket of another housing of a door opening system in accordance with some examples of this technology;

FIG. 3B provides a cross sectional view of the housing of the door opening system from FIG. 3A in accordance with some examples of this technology;

FIG. 4A provides a front, perspective view of another housing for a door opening system in accordance with some examples of this technology;

FIG. 4B provides a front, perspective view of a bracket of the housing of the door opening system from FIG. 4A in accordance with some examples of this technology;

FIG. 4C provides a front, perspective view of a sliding rail of the housing of the door opening system from FIG. 4A in accordance with some examples of this technology;

FIG. 5 provides a cross sectional view of another housing of a door opening system in accordance with some examples of this technology;

FIG. 6 provides a cross sectional view of another housing of a door opening system in accordance with some examples of this technology;

FIG. 7A provides a close-up perspective view of a latch of a door opening system in accordance with some examples of this technology;

FIG. 7B provides a close-up perspective view of a catch assembly of the door opening system from FIG. 7A in accordance with some examples of this technology;

FIG. 8A provides a front, perspective view of a door opening system with the door in a closed or locked configuration in accordance with some examples of this technology;

FIG. 8B provides a front, perspective view of the door opening system from FIG. 8A with a sliding rail in the raised position in accordance with some examples of this technology;

FIG. 8C provides a front, perspective view of the door opening system from FIG. 8A with the door panel in an open configuration in accordance with some examples of this technology;

FIG. 9 provides front, perspective view of an exemplary foot pedal for the door opening system from FIG. 1A in accordance with some examples of this technology;

FIG. 10 provides a component exploded view of another occupancy indicator system in accordance with some examples of this technology;

FIG. 11A provides a front, perspective view of the occupancy indicator system from FIG. 10 in accordance with some examples of this technology;

FIG. 11B provides a side view of the occupancy indicator system from FIG. 10 in accordance with some examples of this technology;

FIGS. 12A and 12B provide views of the occupancy indicator system from FIG. 10 in accordance with some examples of this technology;

FIG. 13 provides a front, perspective view of another occupancy indicator system in accordance with some examples of this technology; and

FIGS. 14A and 14B provide views of an occupancy indicator system in accordance with some examples of this technology.

### DETAILED DESCRIPTION

Aspects of this invention allow for the closing, opening, and holding (in a closed state) of a door system, including, but not limited to doors for stalls in public restrooms. The problem with the current state of the door systems in restrooms is that: stall doors may use closing and locking mechanisms that require user touch; and stall occupancy is difficult to detect visually, particularly from afar or even remotely by electronic means. Embodiments of the door opening system may address these problems through hands-free or touchless mechanisms and methods that utilize various mechanical, electromechanical, and electronic systems and components. The user of certain embodiments such a device will find the convenience and sanitary use of not having to touch areas and surfaces with exposed body parts in order to perform the functions of opening, closing, of locking a door in order to achieve privacy and or security when entering, occupying, or leaving an environment or contained area. The function and use of the door opening system will allow for use of all ages, genders, and all levels of physical ability/prowess. The door opening system has the ability to operate both mechanically and electromechanically based on the needs and wants of the owner/installer. The door opening system allows for universal ease of installation and acceptance to any door system. The door opening system allows for tool-less accessibility in an emergency situation without compromising the privacy of the user in a normal circumstance.

The door opening system may integrate and function off the internal and surface operational standards of a latch mechanism. The door opening system may allow for the ability to be modular and adaptable to simple mechanical to electronic versions. The door opening system may operate in conjunction of standard features such as, but not limited to, hinges that keep a door ajar at rest position. The door opening system may allow entry to the room/environment without the need to physically touch or contact a handle or latch with any part of the body that is exposed (bare skin). Such embodiments may be referred to, for example and for convenience, as a “touchless” door opening system. The closing of the door also may be managed by the pushing of the door with anything other than bare hands. The closing of the door may engage the latch mechanism to engage upon contact and receivership of the door parallel to the wall or pilaster that it engages with. Aspects of the door opening system may utilize a physical/mechanical (foot operated) pedal/switch that acts to release the locking feature of the door. Embodiments that allow for opening and closing of the door using body parts other than the hands may be referred to, for example and for convenience, as a “hands-free” door opening system.

The door opening system may be utilized for a bathroom stall. In other examples, the door opening system may be utilized for other doors, such as cabinet doors. The door opening system may be easily installed as a retrofit of an existing door system or door stall or existing bathroom doors.

Additionally, the door opening system may provide several features that can address new and emerging needs in the connected/electronic restroom. These new and emerging needs may include, but not be limited to, touchless door locking/unlocking, stall occupancy indication visually as well as continuous tracking and remote reporting, and tracking and reporting various restroom and stall conditions that require maintenance and/or emergency intervention, etc. The door opening system may be provided in a modular manner so that the system and the components of the system can be easily preconfigured prior to installation and/or post installation.

The door opening system can be operated by an individual's foot to avoid having to manually touch any part of the door in order to exit the stall. The components of the door opening system may include one or more of: a release actuator (foot pedal), latch/catch mechanism, a spring/kicker that releases the latch and gives the door a slight push to return to open/un-occupied position, an “occupancy” indication, emergency access control, and utilizing existing “return to position” hinges or actuators. The components of the door opening system may be modular. Additionally, the components of the door opening system may be “totemic”, unobtrusive, do not significantly impact passageway, and/or minimize intrusion into the path of travel. The components of the door opening system may allow for a system to have an integrated look to the current and present existences of the door and wall/pilaster.

A bracket may be mounted to the pilaster (door frame) of the bathroom stall. A rail may be slidably mounted to the bracket that can move (slide) in the vertical direction. The door panel may include a latch biased towards the pilaster. When the door is closed, the latch engages and is held in place by a notch in the rail. To open the door, an individual may lift the rail with a foot to raise an opening below the notch which aligns with and releases the latch causing the door to swing open.

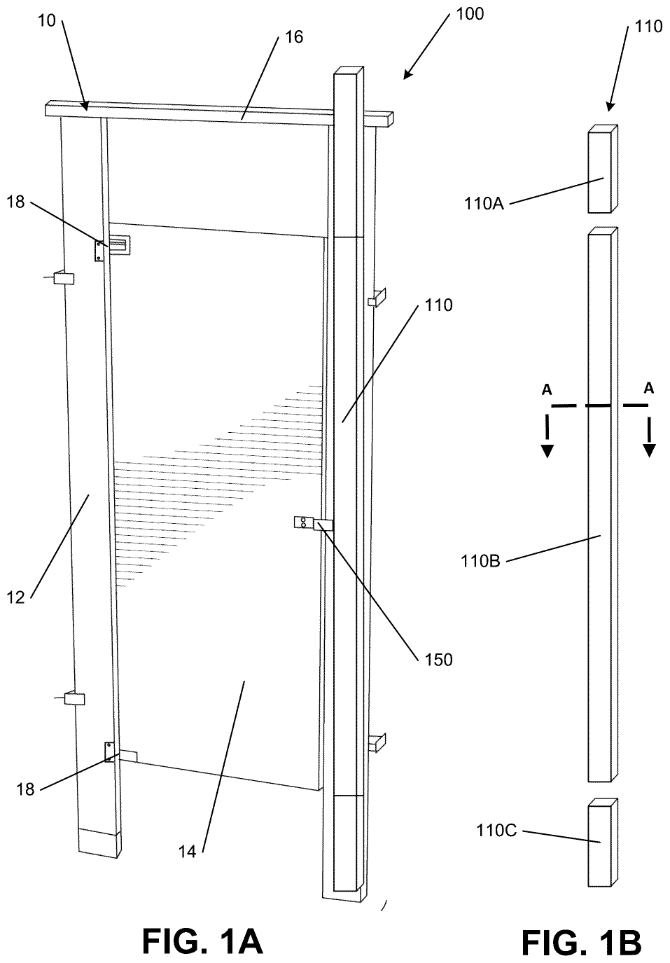

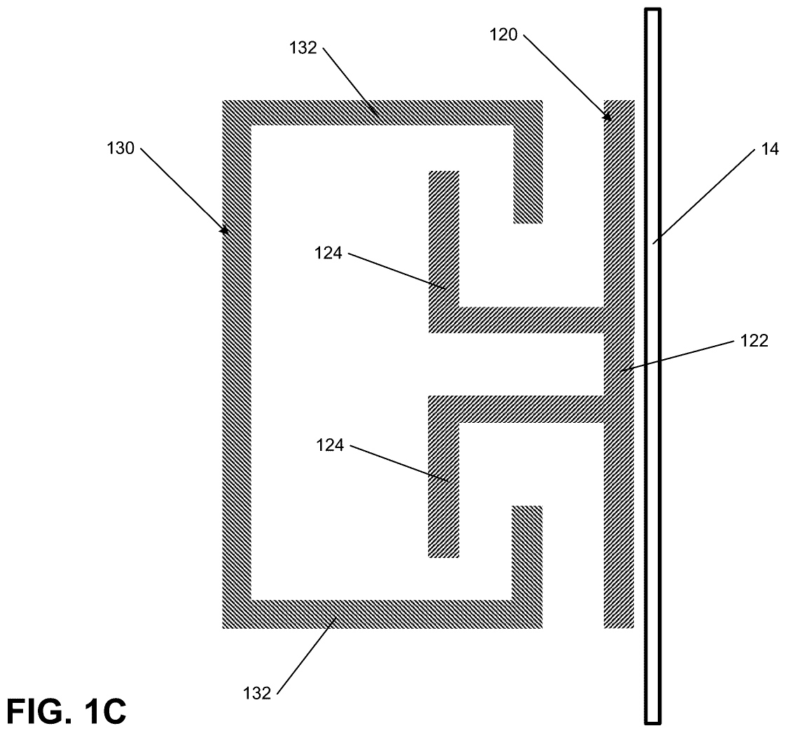

In the figures, FIG. 1A provides a front, perspective view; FIG. 1B provides a component view of a housing 110; and FIG. 1C provides across sectional view taken along section line A-A in FIG. 1B of the housing 110 of a door opening system 100 in accordance with some examples of this technology.

An exemplary door frame assembly 10 may include a door panel 14 supported by pilasters 12 that may be mounted on the floor and by one or more hinges 18. The door frame assembly 10 may be used typically in a modular manner using partition dividers and partition components (i.e. doors, panels, pilasters, posts, headrails, etc.). The pilasters 12 may also be suspended from structural members above a suspended ceiling and/or ceiling tiles. The door frame assembly 10 may also include a headrail 16 spanning above the door panel 14 between the pilasters 12. These partition components of the door frame assembly 10 may be made by various materials including laminates, baked enamel, plastic, and stainless steel and may be offered as products comprising parts in an installation kit or retro-fit kit. The assembly and use of these partition components as functional stalls depends on a wide variety of installation and door hardware (i.e. door hinges 18, door latches, etc.). Common use stall doors generally open inwardly. However, special purpose stalls (for people with special needs) may open outwardly.

The hinges 18 may be typical hinges known and used with door assemblies. In one embodiment, the hinges 18 may be a spring-loaded door panel hinge. A spring-loaded door panel hinge that may keep the door panel 14 ajar (by a few inches or more) enough for a user to detect stall availability (or occupancy) and to facilitate entry. Upon entering a stall, a user has to push against the door against a swing stop. The swing stop may be typically a door latch hardware with a metal tab extension that acts as a stop to the swinging action of the door. The door latching itself may require finger action, typically rotation or sliding of a lever.

The door opening system 100 may include a housing 110 mounted to the pilaster 12 of the door frame assembly 10 and a latch 150 mounted on the door panel 14 configured to engage and disengage the housing 110 to provide a door opening system 100. The latch 150 may be a typical door latch, but other types of latches may be used, e.g. ball-and-socket, etc. The door opening system 100 may be installed as a retro-fit modular system onto the door frame assembly 10.

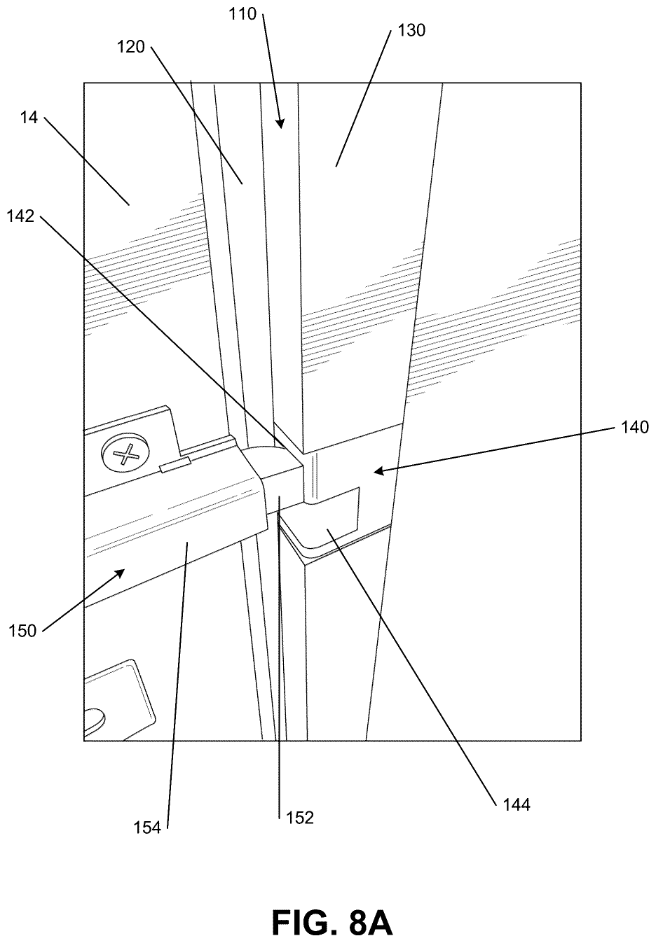

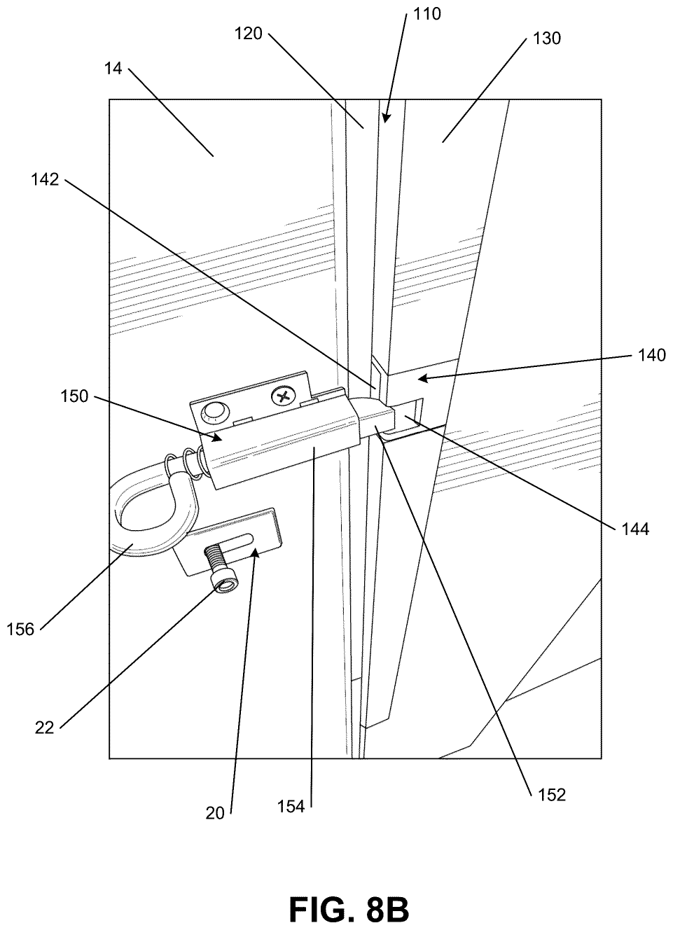

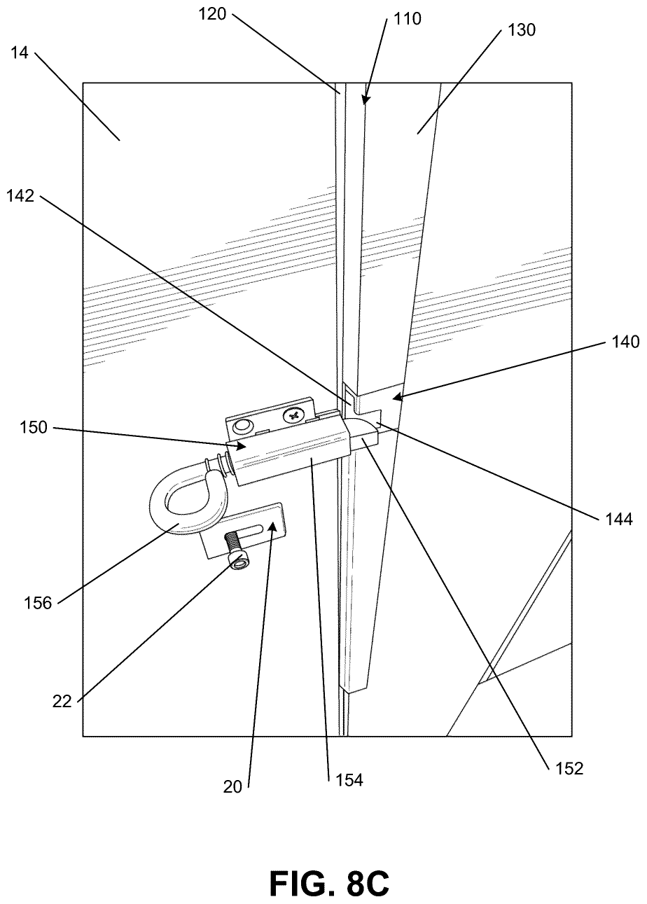

The housing 110 may include a bracket 120 mounted to the pilaster 12 and a rail 130 slidably mounted to the bracket 120. The rail 130 mounted to the bracket 120 may define a vertical channel between the rail 130 and the bracket 120. The rail 130 may slide in a vertical direction along the bracket 120. As will be explained in more detail below with respect to FIGS. 8A-8C, when the door panel 14 is closed, the latch 150 is held in place in a catch assembly 140 in the rail 130. The catch assembly 140 may include both a notch 142 to hold the latch 150 and an opening 144 aligned below the notch 142 on the rail 130. When the rail 130 is slidably moved in a vertical direction, the opening 144 aligns with and releases the latch 150, thereby causing the door panel 14 to swing open. The bracket 120 and rail 130 may include various finishes (e.g. powder coatings) that can be applied to improve their ability to slide relative to each other. These various finishes on the bracket 120 and the rail 130 may help improve the lubrication between these components.

The housing 110, bracket 120, and rail 130 may be single monolithic vertical pieces. Alternatively, the housing 110 (bracket 120 and rail 130) may include multiple separate sections, such as three sections as provided in FIG. 1B. The housing 110 may include a top section 110A, a middle section 110B, and a bottom section 110C. The middle section 110B may include the catch assembly 140. This alternative construction may allow the catch assembly 140 to be made of a more durable (e.g. tougher) material (e.g. stainless steel) than the top section 110A and the bottom section 110C (e.g. aluminum). Using more durable material for the middle section 110B and the catch assembly 140 may be preferable given the constant impacts from the latch 150 against the catch assembly 140. Additionally, the middle section 110B of the housing 110 may be the same height as the door panel 14. The dimensions of the housing sections 110A-C may vary in any particular implementation. For example, the middle section 110B shown in FIG. 1B is longer than both the top section 110A and the bottom section 110C. In alternative implementations, one or more of the top section 110A and/or the bottom section 110C may be longer than the middle section 110B.

The bottom section 110C may house a water sensor at the very bottom of the bottom section 110C where the bottom section 110C meets the floor. The bottom section 110C may include small openings around a bottom portion of the bottom section 110C that will allow water on the floor to flow to the water sensor. The small openings may be for example, open vertical slots, approximately 0.5 inches long.

The bottom section 110C may also provide a weight-bearing support to the panels of the stall if needed. The bottom section 110C may be a one-piece of a rectangular extrusion. The bottom section 110C may be mounted onto the middle section 110B with screws or fasteners at the exact height of a distance from the floor to the lower edge of the middle section 110B and the main housing 110. The adjustable mounting screws keep the bottom section 110C firmly on the floor as a weight-bearing extension of the middle section 1108. The length (height) of the bottom section 110C may be slightly longer than the clearance between the floor and the bottom edge of the middle section 1106, such as two inches.

Once the rail 130 is mounted to the bracket 120 and the middle section 1106, the bottom section 110C may stay firmly in place inside the middle section 1108. The water sensor, as well as other electronic component parts, may be wired through a wire harness that runs through the main housing 110 and through the top section 110A. The wire harness may extend above the ceiling, such as a suspended tile ceiling to a low voltage power source.

The top section 110A may act as the wiring conduit to the low voltage power supply source. Additionally, the top section 110A may accommodate the flipping of a mechanical visual flag on the outside of the stall when the door panel 14 is locked. The top section 110A may be connected to the middle section 110B with a use of a short coupling that may be made of PVC that may allow a “press-fit” operation by hand.

FIG. 1C illustrates a horizontal cross-section view of the housing 110. As illustrated in FIG. 1C, the housing 110 provides physical modularity with a set of two rail profiles that slide into one another and can be locked to form the main housing 110, such as the bracket 120 and the rail 130. The rail 130 mounted to the bracket 120 may define a vertical channel between the rail 130 and the bracket 120. The bracket 120 may be a flat base 122 that includes a pair of C-edges 124 that extend perpendicularly from the flat base 122. The bracket 120 may be mounted vertically on the pilaster 12 against which the door panel 14 locks (opposite of the hinged side). The mounting of the bracket 120 against the pilaster 12 may be performed with fasteners, such as screws, across a pattern of open slots and/or holes across the centerline of the bracket 120. The rail 130 may include a C-channel or rectangular channels 132 that creates the form factor of the space inside and slides top-down around the C-edge profile 124 of the bracket 120. The C-channels 132 on the rail 130 may engage, cooperate, and slide along the C-edge profile 124 on the bracket 120.

The bracket 120 and the rail 130 may match the length of the door panel 14. For example, the matching lengths may ensure there are no edges that could snag, e.g. on the user, something the user is carrying, etc. The cross-section of the bracket 120 and the rail 130 together may comprise a rectangle that may be as small as 2 inches wide (front) and 1 inch deep (side). The bracket 120 and/or the rail 130 may be aluminum or stainless steel or other materials known and used for doors. Additionally, the bracket 120 and/or the rail 130 may be formed through extrusion, forging, forming, rolling, drawing, welding, or other processes.

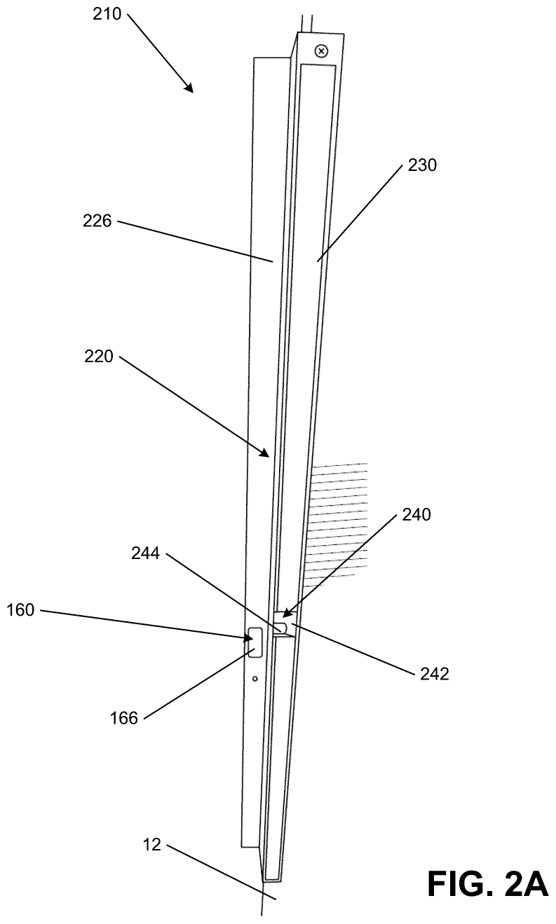

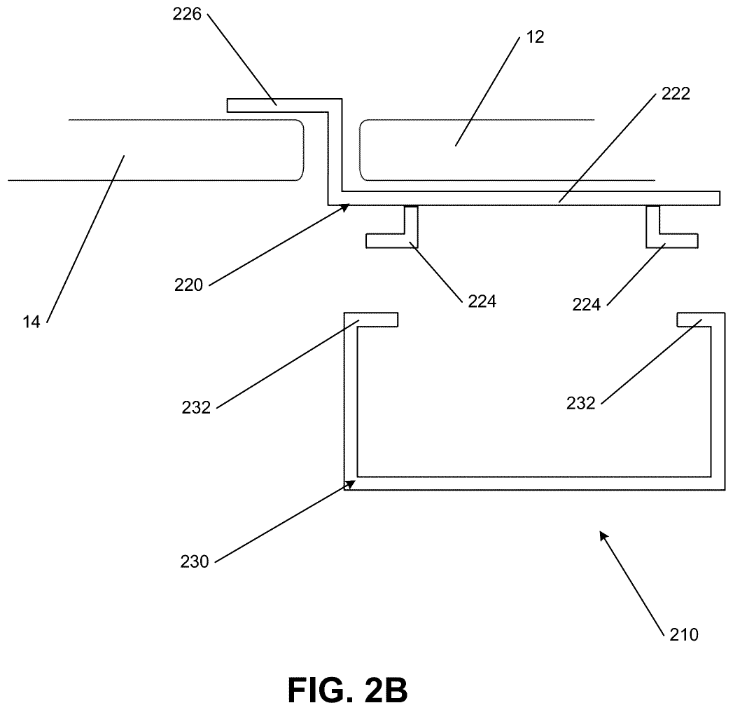

FIGS. 2A and 2B illustrate an alternate embodiment of the housing. FIG. 2A provides a front, perspective view of a housing 210 in accordance with some examples of this technology. FIG. 2B provides a cross sectional view of the housing 210 along with the pilaster 12 and door panel 14 in accordance with some examples of this technology.

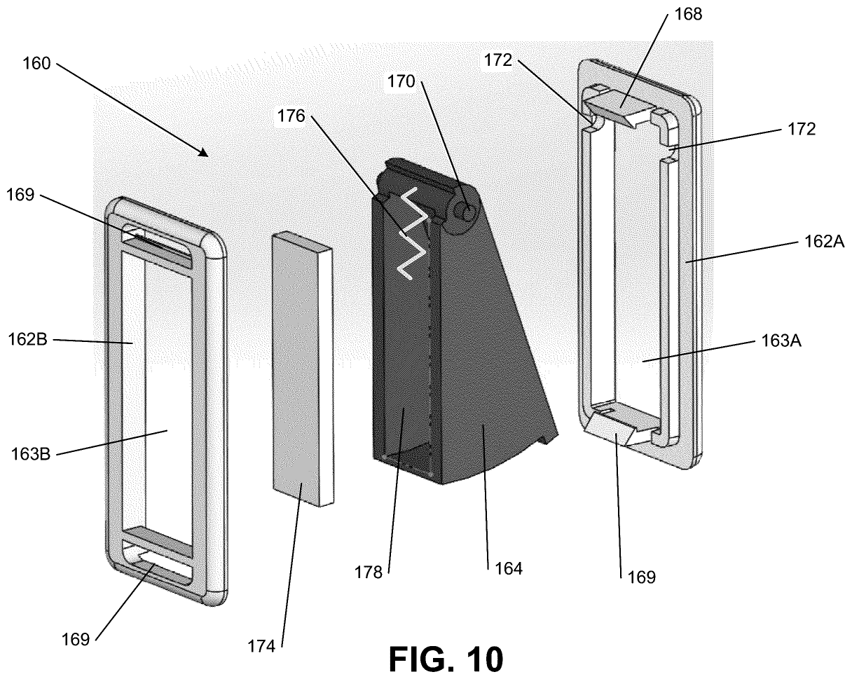

As illustrated in FIG. 2A, the housing 210 may include a bracket 220 mounted to the pilaster 12 and a rail 230 slidably mounted to the bracket 220. The rail 230 may slide in a vertical direction along the bracket 220. The bracket 220 may also include an extension arm 226 or lip that extends away from the pilaster 12 and towards the door panel 14. The extension arm 226 may provide a dead-stop for the swinging door panel 14 in the closed position. The extension arm 226 may be in the form of a Z-edge. Additionally, the extension arm 226 may facilitate the locking function of the door panel 14. Additionally, the extension arm 226 may include a receptacle 166 for an occupancy indicator 164 as will be described in further detail with respect to FIGS. 10A-14.

The catch assembly 240 may include both a notch 242 to hold the latch 150 and an opening 244 aligned below the notch 242 on the rail 230. When the rail 230 is slidably moved in a vertical direction, the opening 244 aligns with and releases the latch 150, thereby causing the door panel 14 to swing open.

FIG. 2B illustrates a horizontal cross-sectional view of the housing 210. The housing 210 may include a bracket 220 and a slidably engaged rail 230. As illustrated in FIG. 2B, the bracket 220 attaches to the pilaster 12 with one or more fasteners and/or screws. The bracket 220 may be defined by a flat base 222 that includes a pair of L-edges 224 that extend perpendicularly from the flat base 222. The bracket 220 may include an extension arm 226 that extends away from the pilaster 12 towards the door panel 14. With the door panel 14 in the closed configuration (as shown in FIG. 2B), the door panel 14 is door stopped against the extension arm 226. The bracket 220 may be mounted vertically on the pilaster 12 against which the door panel 14 locks (opposite of the hinged side). The mounting of the bracket 220 against the pilaster 12 may be performed with fasteners, such as screws, across a pattern of open slots and/or holes across the centerline of the bracket 220. The rail 230 may include a C-channel or rectangular channel 232 that creates the form factor of the space inside and slides top-down around the C-edge profile 224 of the bracket 220. The C-channels 232 on the rail 230 may engage and slide along the C-edge profile 224 on the bracket 220.

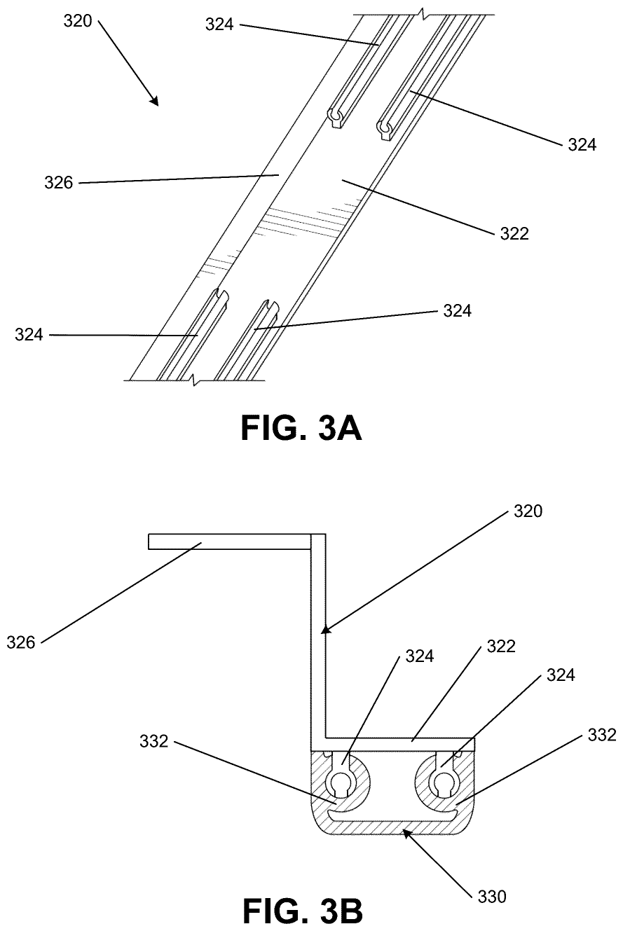

FIGS. 3A and 3B illustrate another alternate embodiment of the housing. FIG. 3A provides a front, perspective view of a portion of a bracket 320 of another housing 310 in accordance with some examples of this technology. FIG. 3B provides a cross sectional view of the housing 310 with the bracket 320, and a slidably engaged rail 330 in accordance with some examples of this technology.

As illustrated in FIG. 3A, the bracket 320 may include one or more C-shaped channels 324 along the front-side or flat base 322 of the bracket 320. The bracket 320 may also include an extension arm 326 or lip that extends away from the pilaster and towards the door panel. Similar to the extension arm 226 in FIGS. 2A and 2B, the extension arm 326 may provide a dead-stop for the swinging door panel in the closed position. The extension arm 326 may be in the form of a Z-edge. Additionally, the extension arm 326 may facilitate the locking function of the door panel.

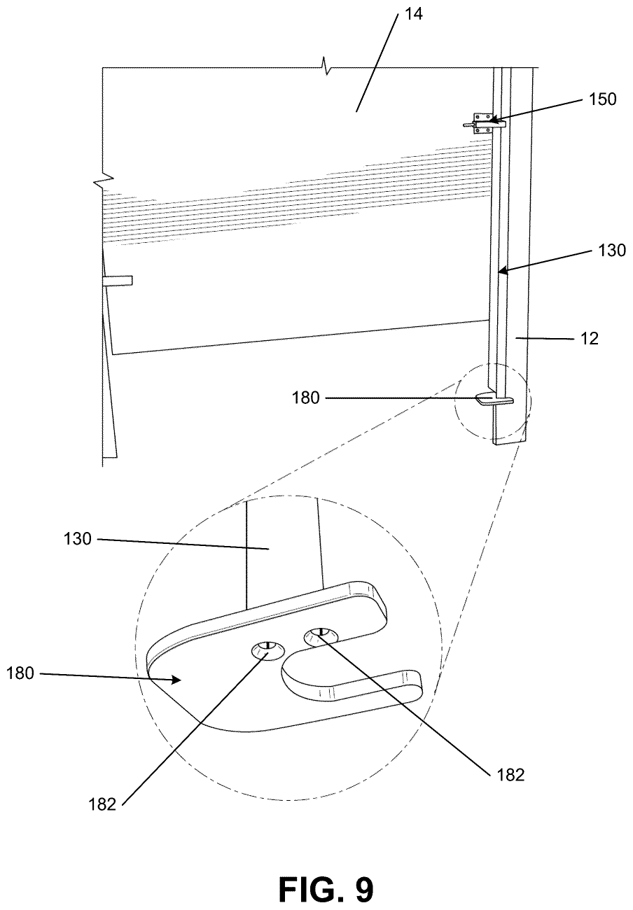

FIG. 3B illustrates a horizontal cross-sectional view of the housing 310. The housing 310 may include a bracket 320 and a slidably engaged rail 330. The bracket 320 may attach to a pilaster with one or more fasteners and/or screws. The bracket 320 may be a flat base 322 with one or more C-shaped channels 324 along the front-side of the bracket 320. The rail 330 may include a one or more rods 332 that are received in and slide in corresponding C-shaped channels 324 of the bracket 320. The housing 310 may include a catch assembly (not shown) to engage with the latch similar to the catch assembly as shown and described in FIGS. 1A-2B. Additionally, the rods 332 may provide a mounting location for a foot pedal and allow for self-tapping fasteners inside the rods 332. The self-tapping fasteners may be bolts, screws, pins, etc. The foot pedal may be mounted to the bottom of the sliding rail 330 as will be explained more below with respect to FIG. 9.

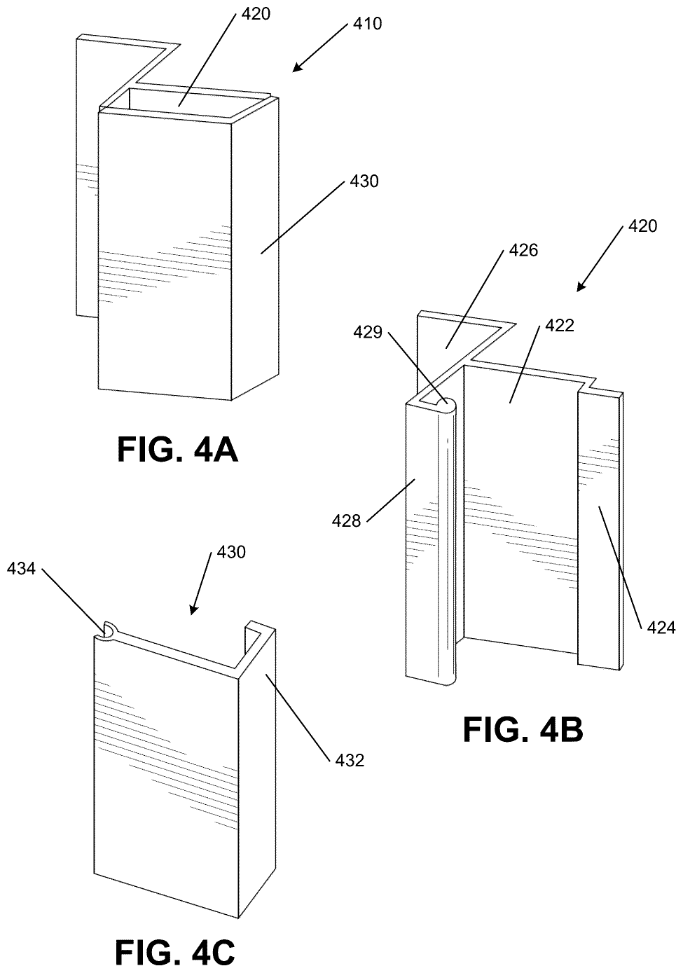

FIGS. 4A-4C illustrate yet another alternate embodiment of the housing. FIG. 4A provides a front, perspective view of a housing 410 in accordance with some examples of this technology. FIG. 4B provides a front, perspective view of a bracket 420 of the housing 410 in accordance with some examples of this technology. FIG. 4C provides a front, perspective view of an L-shaped rail 414 of the housing 410 in accordance with some examples of this technology.

As illustrated in FIG. 4A, the housing 410 may include a bracket 420 mounted to the pilaster and an L-shaped rail 430 slidably mounted to the bracket 420. The housing 410 may provide an L-shaped profile that provides a privacy screen over the gap between the door panel and the door frame. The L-shaped rail 430 may slide in a vertical direction along the bracket 420. The bracket 420 may include an extension arm 426 or lip that extends away from the pilaster and towards the door panel. The extension arm 426 may provide a dead-stop for the swinging door panel in the closed position. The extension arm 426 may be in the form of a Z-edge. Additionally, the extension arm 426 may facilitate the locking function of the door panel.

As illustrated in FIG. 4B, the bracket 420 may include a flat base 422 that includes C-edge 424 that extends perpendicular from the flat base 422 and opposite of door panel. The bracket 420 may also include a rail arm 428 with a circular edge 429. The rail arm 428 may extend away from the bracket 420 and be located adjacent to the door panel. The L-shaped rail 430 may include an L-shape with a rectangular channel 432 on one side and a C-shaped channel 434 along another side. The rectangular channel 432 of the L-shaped rail 430 may engage and cooperate with the rail arm 428 of the bracket 420. The circular edge 429 may be received in and slide in the corresponding C-shaped channel 434. The housing 410 may include a catch assembly (not shown) to engage with the latch similar to the catch assembly as shown and described in FIGS. 1A-2B.

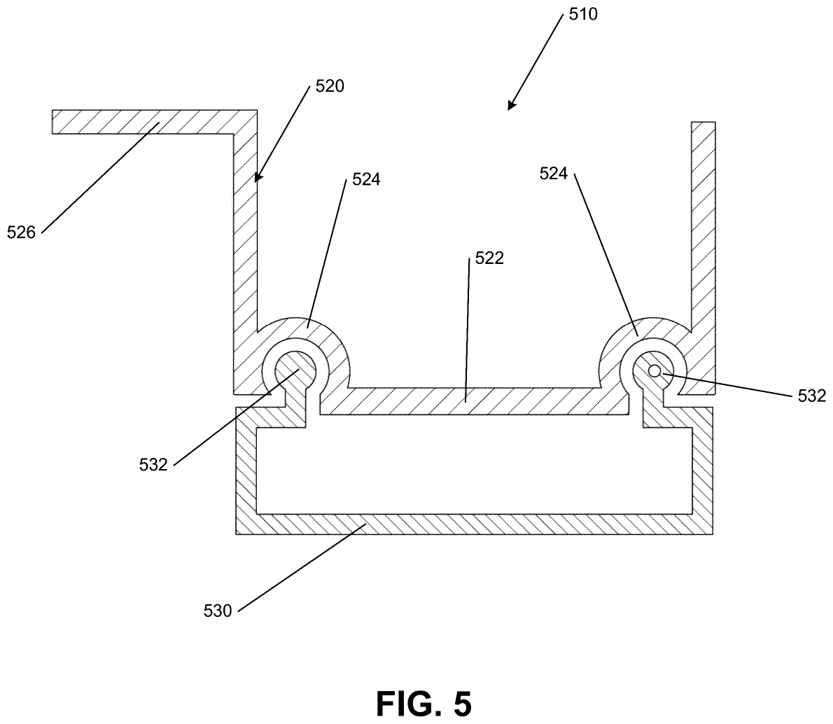

FIG. 5 illustrates another alternate embodiment of the housing. FIG. 5 provides a cross sectional view of a housing 510 with a bracket 520 and a slidably engaged rail 530 in accordance with some examples of this technology.

As illustrated in FIG. 5, the bracket 520 may include one or more C-shaped channels 524 along the front-side 522 along the bracket 520. The bracket 520 may also include an extension arm 526 or lip that extends away from the pilaster and towards the door panel. Similar to the extension arm 226 in FIGS. 2A and 2B, the extension arm 526 may provide a dead-stop for the swinging door panel in the closed position. The extension arm 526 may be in the form of a Z-edge. Additionally, the extension arm 526 may facilitate the locking function of the door panel.

The housing 510 may include a bracket 520 and a slidably engaged rail 530. The bracket 520 may attach to a pilaster with one or more fasteners and/or screws. The bracket 520 may include one or more C-shaped channels 524 along the front-side 522 of the bracket 520. The rail 530 may include a one or more rods 532 that are received in and slide in corresponding C-shaped channels 524 of the bracket 520. The housing 510 may include a catch assembly (not shown) to engage with the latch similar to the catch assembly as shown and described in FIGS. 1A-2B. Additionally, the rods 532 may provide a mounting location for a foot pedal and allow for self-tapping fasteners inside the rods 532. The self-tapping fasteners may be bolts, screws, pins, etc. The foot pedal may be mounted to the bottom of the sliding rail 530 as will be explained more below with respect to FIG. 9.

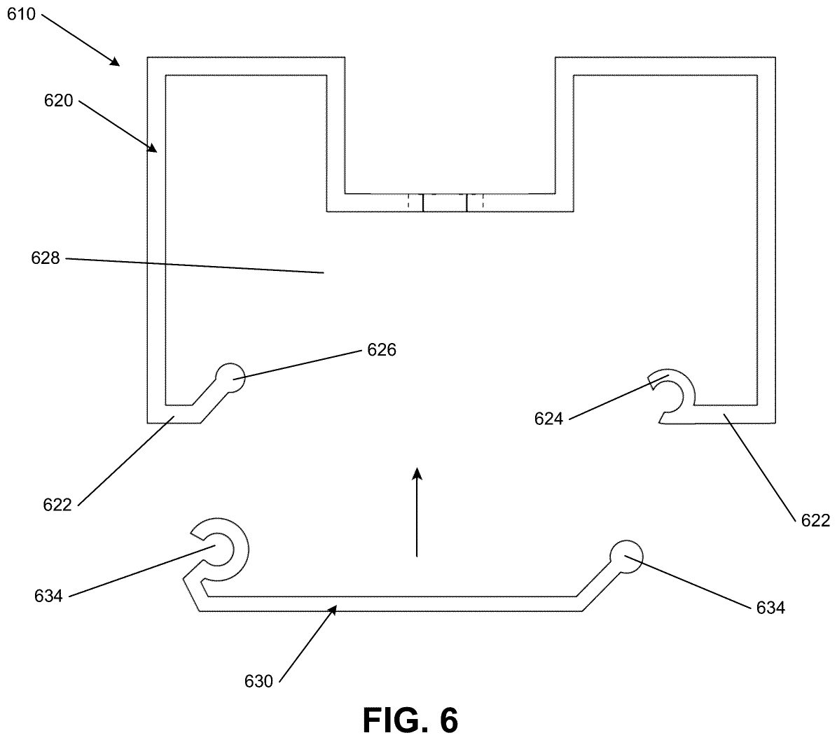

FIG. 6 illustrates another alternate embodiment of the housing. FIG. 6 provides a cross sectional view of a housing 610 with a bracket 620 configured for electrical connections, and a slidably engaged rail 630 in accordance with some examples of this technology. The bracket 620 may allow for electrical wires to run through the housing 610.

As illustrated in FIG. 6, the housing 610 may include a bracket 620 and a slidably engaged rail 630. The bracket 620 may attach to a pilaster with one or more fasteners and/or screws. The bracket 620 may form an electrical housing 628 with a first C-shaped channel 624 and a first rod 626 located on an opposite side from the first C-shaped channel 624. The first C-shaped channel 624 and the first rod 626 may be along a front-side 622 along the bracket 620. The rail 630 may include a second rod 634 that may be received in and slide in the corresponding C-shaped channel 624 of the bracket 620. The rail 630 may also include a second C-shaped channel 632, with the first rod 626 that may be received in and slide in the corresponding C-shaped channel 632. The housing 610 may include a catch assembly (not shown) to engage with the latch similar to the catch assembly as shown and described in FIGS. 1A-2B. Additionally, the rods 626, 634 may provide a mounting location for a foot pedal and allow for self-tapping fasteners inside the rods 626, 634. The self-tapping fasteners may be bolts, screws, pins, etc. The foot pedal may be mounted to the bottom of the sliding rail 630 as will be explained more below with respect to FIG. 9.

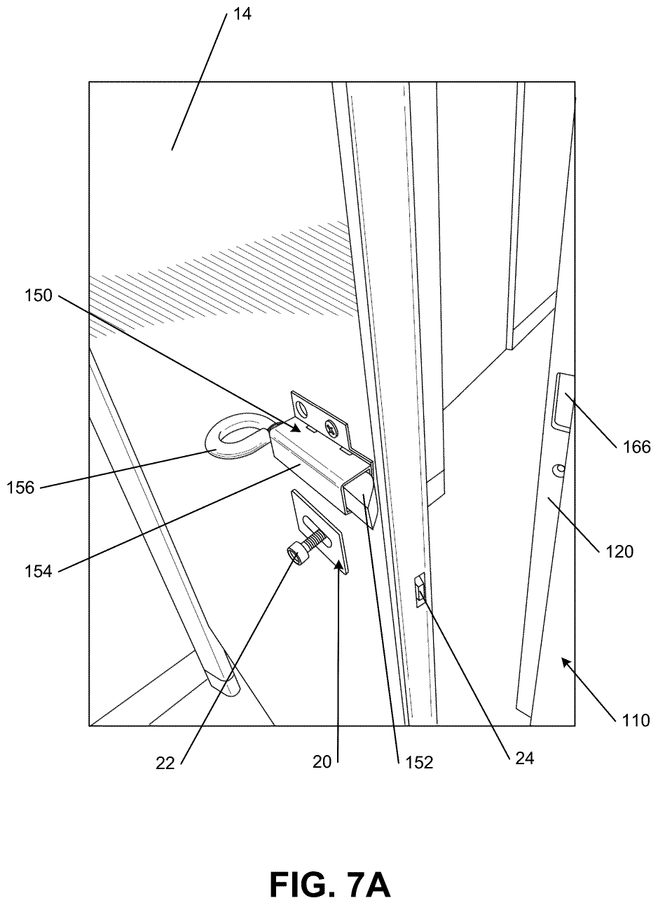

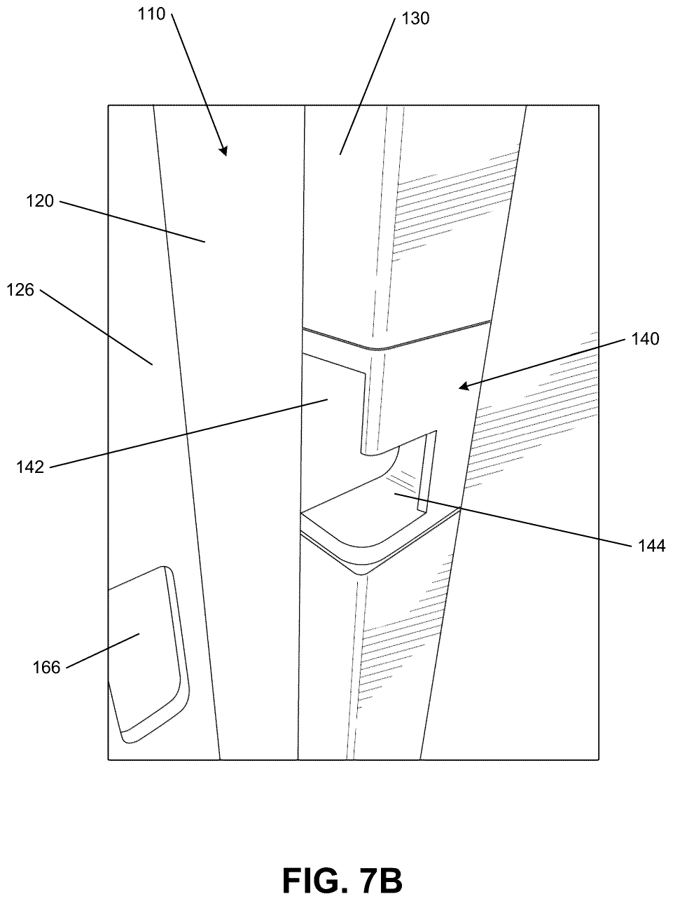

FIGS. 7A and 7B illustrate close-up views of components of the door opening system 100. FIG. 7A illustrates a close-up perspective view of a latch 150 mounted on a door panel 14 in an open position. FIG. 7B illustrates a close-up perspective view of the catch assembly 140 as part of the housing 110. The latch 150, housing 110, and catch assembly 140 may be installed as a retro-fit modular system onto the door frame assembly 10.

As illustrated in FIG. 7A, the latch 150 may be configured to engage and disengage the catch assembly 140 to provide a door opening system 100. The latch 150 may be a typical door latch, but other types of latches may be used, e.g. ball-and-socket, etc. The latch 150 may include a spring-loaded bolt 152 that extends through a latch housing 154. The latch 150 may also include a pull lock 156 that extends through the latch housing 154 and is connected to the spring-loaded bolt 152. The pull lock 156 may be utilized to pull the spring-loaded bolt 152 as an option to using the door opening system 100. As will be explained in more detail below, the spring-loaded bolt 152 may engage with the catch assembly 140 in the rail 130 and the housing 110.

The door panel 14 may also include a secondary lock 20. The secondary lock may be a slide bolt latch as known and used. Other types of slide bolt latches may be utilized. The secondary lock 20 may be a surface mount latch or may be integrally installed within the door panel 14. The secondary lock 20 may provide added security and locking of the door panel 14 in addition to the latch 150. The secondary lock 20 may include both a slide 22 and a locking bolt 24 that may be configured to engage with the housing 110.

When the door panel 14 is closed, the latch 150 is held in place in a catch assembly 140 in the rail 130. The catch assembly 140 may include both a notch 142 to hold the latch 150 and an opening 144 aligned below the notch 142 on the rail 130. FIG. 7B illustrates the catch assembly 140 with both the notch 142 and the opening 144 aligned below the notch 142 on the rail 130 and the housing 110. When the rail 130 is slidably moved in a vertical direction, the opening 144 aligns with and releases the spring-loaded bolt 152 of the latch 150, thereby causing the door panel 14 to swing open. FIG. 7B also shows a receptacle 166 for an occupancy indicator 164 as will be shown and detailed further below and in FIGS. 10A-14.

FIGS. 8A-8C illustrate the operation of the door opening system 100 and opening the door panel 14. FIG. 8A shows the door panel 14 in a closed or locked configuration. FIG. 8B shows the rail 130 in the raised position. FIG. 8C shows the door panel 14 in an open configuration.

As illustrated in FIG. 8A, the door panel 14 is in a closed or locked configuration with the latch 150 and bolt 152 engaged with the notch 142 of the catch assembly 140. When the door panel 14 is closed, the rail 130 may be in the low configuration so that the notch 142 is aligned with the bolt 152 to hold the bolt 152 in the catch assembly 140. When the door panel 14 is closed, the latch 150 and bolt 152 engages and is held in place by the notch 142 in the catch assembly 140 of the rail 130 and housing 110. The latch 150 and bolt 152 may be biased towards the pilaster 12.

The door opening system 100 can be operated by a release actuator. Example release actuators that may be utilized may include, but not be limited to a mechanical means, such as a foot pedal (as illustrated in FIG. 9), a switch, a push button, a motion sensor, or an electronic release. One exemplary release actuator may be an individual's foot to avoid having to manually touch any part of the door in order to exit the stall. As illustrated in FIG. 8B, to open the door panel 14, an individual may lift the rail 130 with a foot to raise the opening 144. When the rail 130 is slidably moved in a vertical direction, the opening 144 moves up and aligns with and releases the latch 150, thereby causing the door panel 14 to swing open. The raising of the rail 130 moves the opening 144 to align with and release the latch 150 and bolt 152 causing the door to swing open. The rail 130 may be slidably mounted to the bracket 120 that is mounted to the pilaster (door frame) 12 of the bathroom stall. The rail 130 may move and slide in the vertical direction.

FIG. 8C shows the releasing of the latch 150 and bolt 152 from the catch assembly 140 with the door swinging open. A magnet or other biasing means (e.g. a spring or leaf spring) may be used to give the door panel 14 a push or kick when the latch 150 and bolt 152 is released. When the door panel 14 is released and opened, gravity and the weight of the rail 130 lowers the rail 130 back down.

FIG. 9 illustrates an exemplary physical/mechanical (foot operated) pedal/switch 180 that acts to release the locking feature of the door panel 14. As was explained above with the housing 110 and the rail 130, a foot pedal 180 may be mounted to the bottom of the sliding rail 130. For example, the foot pedal 180 may include fastener locations 182 for self-tapping fasteners into the rail 130. As discussed above, the rail 130 may include rods that provide mounting locations for the foot pedal 180 and allow for self-tapping fasteners inside the rods, such as bolts, screws, pins, etc. A user may lift up on the foot pedal 180 to slidably move the rail 130 in the vertical direction, thereby releasing the latch 150 and bolt 152 from the catch assembly 140 and opening the door panel 14.

In other embodiments, the foot pedal 180 may be an example release actuator. For example, the foot pedal 180 may include a “bump” feature to release the door panel 14 and to provide the ability to release the door with a cane or a wheelchair.

In other embodiments, the foot pedal 180 may be placed and/or oriented to make the foot pedal 180 less accessible to other people outside the stall while the stall is occupied. For example, the foot pedal 180 may be rotated or angled so the foot pedal 180 is more on the interior side of the bathroom stall.

In another embodiment, the door opening system 100 may be installed on one or more walls that define a bathroom stall, e.g. as an alternative to being mounted to the pilaster 12 of the door frame assembly 10. In yet another embodiment, the door opening system 100 may be installed within a portable restroom, bathroom, or toilet system, such as, for example, porta-potty. The door opening system 100 within the portable restroom, bathroom, or toilet system may include, but not be limited to, touchless door locking/unlocking, restroom occupancy indication, and tracking and reporting various restroom and stall conditions that require maintenance and/or emergency intervention, etc. The door opening system 100 installed within the portable restroom may be provided in a modular manner so that the system and the components of the system can be easily preconfigured prior to installation and/or post installation.

FIGS. 10-14B illustrate exemplary embodiments of occupancy indicator systems. The door occupancy indicator may improve on current occupancy indicators by being pushed away from the door panel 14.

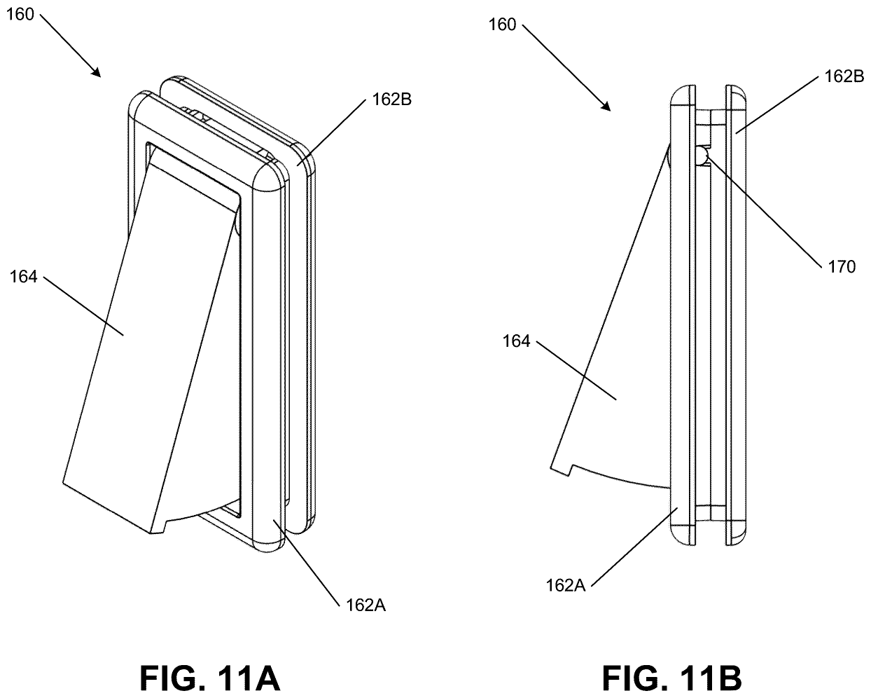

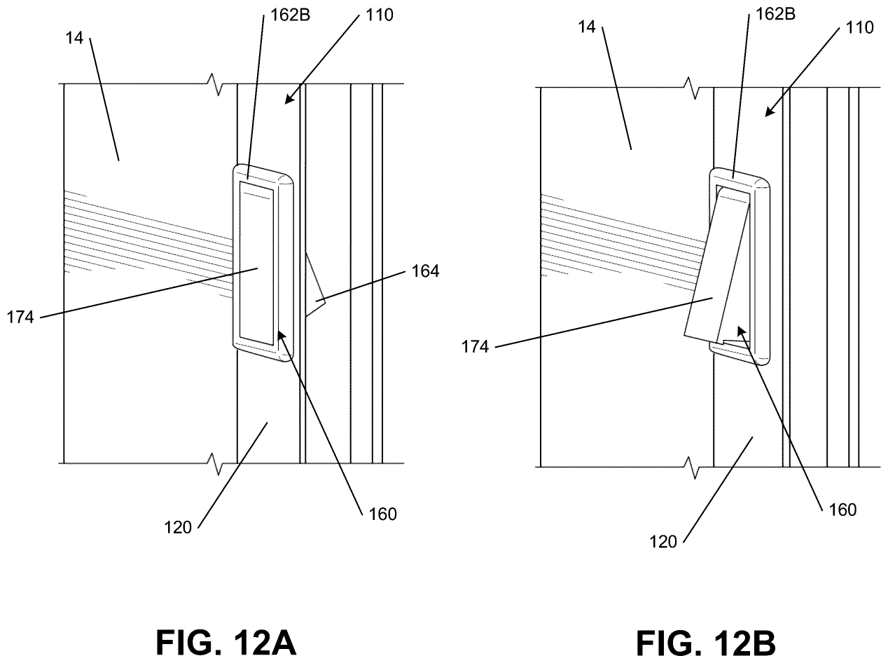

FIGS. 10-12B illustrate another exemplary occupancy indicator system 160. FIG. 10 illustrates a component exploded view of the occupancy indicator system 160. FIG. 11A shows a front perspective view of the occupancy indicator system 160. FIG. 11B shows a side view of the occupancy indicator system 160. FIGS. 12A and 12B illustrate views of the occupancy indicator system 160 installed in the door panel 14 and/or housing 110 or bracket 120 or extension arm 126

The occupancy indicator system 160 may include one or more brackets that may be defined by an inner bracket 162A and an outer bracket 162B engaged with the inner bracket 162A. The inner bracket 162A may be located within an interior of the door panel 14 and within an inner portion of the receptacle 166. The outer bracket 162B may be located within an exterior of the housing 110 and the housing bracket 120 and within an outer portion of the receptacle 166. The inner bracket 162A may include one or more bracket tabs 168. The outer bracket 162B may include one or more bracket slots 169 that correspond to each of the one or more bracket tabs 168. The bracket tabs 168 may snap-fit and engage within the corresponding bracket slots 169 to lock the inner bracket 162A and the outer bracket 162B together, thereby locking the inner bracket 162A and the outer bracket 162B together within the receptacle 166. In another embodiment, the bracket tabs 168 may be located on the outer bracket 162B and the bracket slots 169 may be located on the inner bracket 162A. The inner bracket 162A may include an opening 163A within the inner bracket 162A. The outer bracket 162B may include an opening 163B within the outer bracket 162B.

The occupancy indicator system 160 may also include an occupancy indicator 164. The occupancy indicator 164 may be sized and shaped to fit within and extend through the opening 163A of the inner bracket 162A and the opening 163B of the outer bracket 162B. The occupancy indicator 164 may be wedge-shaped and weighted such that the occupancy indicator 164 hangs flush with the housing 110 and the housing bracket 120 and/or the extension arm when the door is opened as shown by way of example in FIG. 12A. For example, the occupancy indicator 164 may have a weight distribution such that the occupancy indicator's center of gravity is perpendicular to (e.g., plumb with) a line (e.g., an imaginary line) defined by and parallel with the pivot pin 170. When the door closes and pushes against an inside portion 163 of the occupancy indicator 164, the occupancy indicator 164 pivotably rotates towards the outside of the door panel 14. This allows individuals to see the occupancy indicator 164 from farther away and from different angles. The occupancy indicator 164 may also include a pivot pin 170 that facilitates pivoting of the occupancy indicator 164. The pivot pin 170 may be located toward the top of the occupancy indicator 162 and extend through a pair of pin holes. The pivot pin 170 may also be located with and engaged with one or more pivot slots 172 located in either the inner bracket 162A or the outer bracket 162B or both.

The occupancy indicator system 160 may fit inside a receptacle 166 as illustrated in FIGS. 2A, 7A, and 7B. The occupancy indicator system 160, the inner bracket 162A, and the outer bracket 162B may be press-fit into the receptacle 166 on the housing 110, bracket 120, or extension arm 126. Other mounting systems may be utilized for the occupancy indicator system 160 along the door panel 14. The receptacle 166 may be located anywhere along the housing 110, the bracket 120, and/or the extension arm 126 of the bracket 120. It is preferred that the receptacle 166 and occupancy indicator 164 are located for good visual viewing for both close and far away including, for example, at oblique angles relative to the orientation of the door panel 14.

The occupancy indicator system 160 may include a spring or kicker spring 176 incorporated and the occupancy indicator 164. The spring or kicker spring 176 may give the door panel 14 a slight push when the door panel 14 is opened, so that the user can exit, e.g. providing an extra kick to help the door panel 14 move towards its natural resting position. The spring or kicker spring 176 may also act as a way to push the occupancy indicator 164 out and in with the action of the spring 176. The spring or kicker spring 176 may be a leaf spring, such as a spring steel spring, or another type of spring that provides the same tension all the way through. Other types of springs and biasing means may be utilized to bias the occupancy indicator 164 out and in as part of the occupancy indicator system 160. The spring 176 may be secured to the pivot pin 170 and located within a recess 178 of the occupancy indicator 164. The recess 178 may be covered by an indicator plate 174.

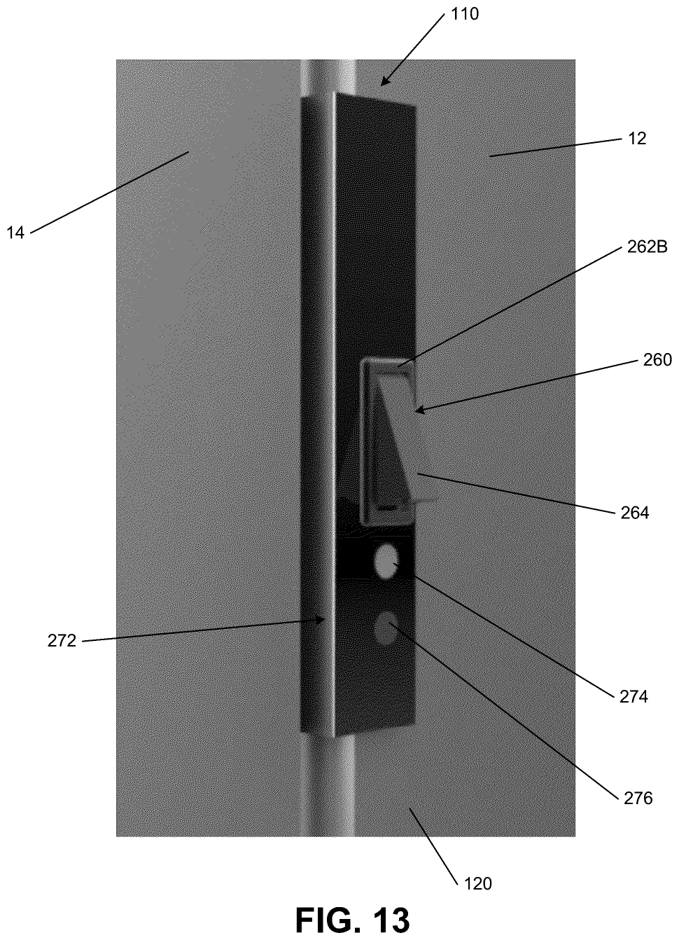

FIG. 13 illustrates another door occupancy indicator system 260 that includes an occupancy indicator wedge 264 as well as an occupancy lighting system 270. The occupancy lighting system 272 may include a red light 274, a green light 276, or both. Other displays may be utilized with the occupancy lighting system 270 and the occupancy indicator wedge 264.

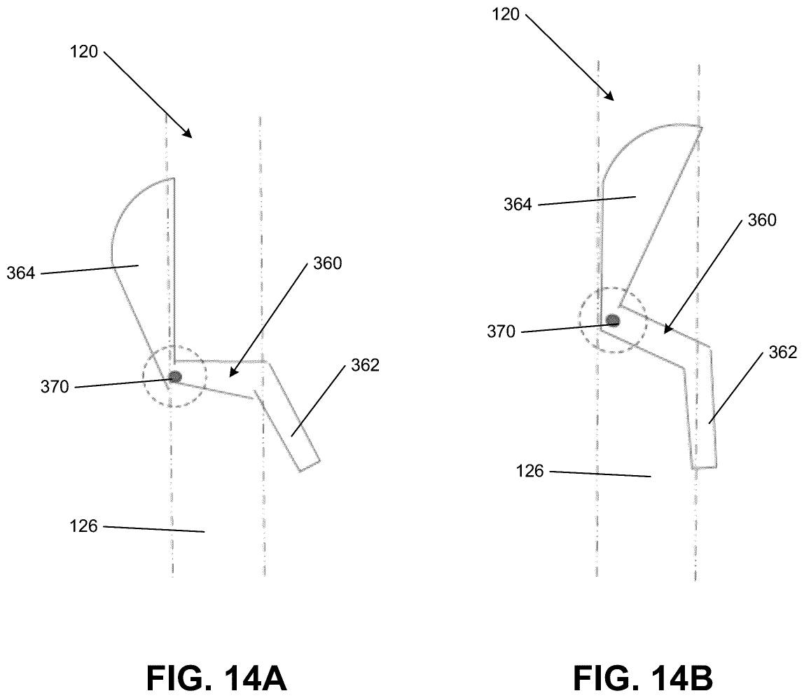

FIGS. 14A and 14B illustrate an example occupancy indicator system 360. FIG. 14A illustrates the occupancy indicator system 360 with an occupancy indicator extended. FIG. 14B illustrates the occupancy indicator system 360 with the occupancy indicator retracted. Generally, the occupancy indicator system 360 may include a paddle 362 on a first end of the occupancy indicator system 360 and an occupancy indicator 364 on a second end opposite the first end. The paddle 362 may be a push rod, plate, or other similar structure, that may be mechanically pushed by the door panel 14 to rotate and/or pivot the occupancy indicator 364. The paddle 362 may be mechanically pushed by the door panel 14 in the closed position to show the occupancy indicator 364 on the outside of the door panel 14. The occupancy indicator system 360 may include a pivot pin 370 located between the paddle 362 and the occupancy indicator 364.

The occupancy indicator system 360 may fit inside a receptacle as illustrated in FIGS. 2A, 7A, and 7B. The occupancy indicator system 360 may also be press-fit into the receptacle on the outside of the door panel 14. Other mounting systems may be utilized for the occupancy indicator system 360 along the door panel 14. The receptacle 366 may be located anywhere along the housing 110, the bracket 120, and/or the extension arm 126 of the bracket 120. It is preferred that the receptacle and occupancy indicator 364 are located for good visual viewing for both close and far away including, for example, at oblique angles relative to the orientation of the door panel 14.

As illustrated in FIGS. 14A and 14B, the occupancy indicator system 360 may include a pivotable occupancy indicator 364 on the outside portion of the door panel 14. When the door panel 14 closes and presses on the paddle 362, the occupancy indicator 364 may rotate about the pivot pin 370 and the occupancy indicator 364 may lift up and/or extend and provides indication when the door panel 14 swings into the closed position. The pivotable occupancy indicator 364 may be a color or provide another indication to show that the door panel 14 is in the open position. For example, the pivotable occupancy indicator 364 may be a green color and/or include “OPEN” when the door is open and the indicator is extended. The pivotable occupancy indicator 364 may also positively indicate whether the door is either open or closed.

The occupancy indicator system 360 may include a spring or kicker spring incorporated into the paddle 362 and the occupancy indicator 364 and act as a way to push the occupancy indicator portion 364 out and in with the action of the spring. This spring or kicker spring may aid in providing notification that the stall or room is in use to other users who need access or use of the room. The spring or kicker spring may be a leaf spring, such as a spring steel spring, or another type of spring that provides the same tension all the way through.

The door occupancy indicator system 160, 260, 360 is in contrast to existing occupancy indicators that are embedded in the pilaster 12 (e.g. red/green) that require individuals to look at the indicator straight-on to be able to see it.

Various other embodiments of the occupancy indicator system 160, 260, 360 may be utilized. The occupancy indicator system 160, 260, 360 may be a metal bracket with roller action with the metal bracket attached to a top portion of the door panel and the roller actuating to turn on or actuate the occupancy indicator. The occupancy indicator system 160, 260, 360 may also be a flashing light beacon on the top of the housing or on the outside of the stall. The occupancy indicator system 160, 260, 360 may also include magnetic sensors to identify and/or actuate the occupancy indicator. The occupancy indicator system 160, 260, 360 may also include electronic display screens located, such as a tablet or electronic display panel outside the restroom or the bathroom stall, and/or on a mobile application, such as using a senior and wayfind system.

In another exemplary embodiment, the door opening system 100 may be utilized with other doors outside of public restroom doors or meeting room doors. For example, the door opening system 100 may be utilized with cabinet doors to avoid the need for knobs/handles. For cabinet doors, the door opening system 100 may be installed on an interior side of the cabinet. A pedal/button above or below the cabinet may be used to move the rail up/down to release the latch. For example, when the pedal or button is pressed with a finger, bumped with a hand/fist/wrist, the rail may move up/down to release the latch and open the cabinet door.

In another exemplary embodiment of the door opening system 100, electromechanical and/or electrical components may be utilized to lift the rail and thereby release the latch and open the door panel. The electromechanical and/or electrical components may include, for example, motors, solenoids, actuators, etc. The electromechanical and/or electrical components, such as actuator, wiring, power source, etc., may be housed in a top section of the housing 110 or in a portion above the door frame. Any necessary electrical wiring may then be routed through the ceiling and/or the housing 110. An independent power source, such as a battery or solar-powered, may also be utilized. Motion sensors and/or other various types of sensors may be utilized to trigger activation of the door opening system 100. Any necessary wiring may also be wired through the housing 110 formed between the bracket 120 and the sliding rail 130.

Additionally, in another exemplary embodiment, the electromechanical and/or electrical components may include a wireless communication module to transmit the current status of the door and other information. For example, the wireless communication module may transmit whether the door is open/closed or occupied/unoccupied. The wireless communication module may also have the capability to utilize a wireless network that will aid in the people/traffic planning of the use of the room, logging open/close actions, summarize actions, visualize and predict the use of the room. The wireless communication module may have the capability to track usage times and predict availability times in certain circumstances. This information may then be transmitted to a light on the outside of the door panel, a light above the door panel, a location outside the restroom to provide status of bathroom stalls, and/or a mobile application.

In another exemplary embodiment, the door opening system 100 may include an alternative actuation that involves pressing down on the foot pedal 180 instead of lifting up the foot pedal 180. By pressing down on the foot pedal 180, the actuation of the rail 130 may slide up or down, thereby aligning the opening 144 in the notch 142 and the catch assembly 140 with the latch 150 and the bolt 152 and releasing the door panel 14 and opening the door panel 14.

Additionally, in another exemplary embodiment, there may be a feature for unlocking the door from the outside of the stall in case of emergencies, such as a help button or other features similar. For example, an emergency help beacon may be located near or around the stall and tied into the help button. The emergency help beacon may include electrical connections for a light and/or sound activation. The emergency help beacon may also tie into a system like “Amber Alert” or “Life Alert” that connects to staff working at the location. The emergency help beacon may be located outside of the main restroom, such as in view of the public and employees to be an another efficient and visual identifier. The emergency help button may be located within reach from the toilet and/or tie into the toilet flush electrical.

One or more aspects discussed herein can be embodied in a method of installing the door opening system and/or occupancy indicator system of the various types described above. In a variety of embodiments, some or all of the steps described below may be combined and/or divided into sub-steps as appropriate. For example, the method of installing the door opening system and/or occupancy indicator system may include one or more of the following steps: attaching a bracket to a pilaster of a door frame and door system; attaching a latch to a door panel supported by the pilasters and one or more hinges, the latch may include a spring-loaded bolt; sliding a slidable rail vertically onto the bracket, the slidable rail may include a catch assembly with a notch and an opening aligned below the notch; and installing an occupancy indicator system onto the bracket, pilaster, or door frame, wherein when the door panel is in the closed position, the door panel pushes against a portion of the occupancy indicator to provide a visual indication that the door panel is in the closed position.

One or more aspects discussed herein can be embodied in a method of using the door opening system and/or occupancy indicator system of the types described above. In a variety of embodiments, some or all of the steps described below may be combined and/or divided into sub-steps as appropriate. For example, the method of using the door opening system and/or occupancy indicator system may include one or more of the following steps: entering a stall or room with a door frame assembly that includes a door panel supported by pilasters and one or more hinges, wherein the door panel may include a latch with a spring-loaded bolt; closing the door panel, thereby automatically engaging the latch and spring-loaded bolt with a catch assembly located on a sliding rail, the catch assembly with a notch and an opening aligned below the notch, with the spring-loaded bolt engaged with the notch; when the door panel is in the closed position, the door panel pushes against a portion of an occupancy indicator to provide a visual indication that the door panel is in the closed position; sliding the sliding rail vertically along a bracket attached to the pilaster, wherein when the sliding rail is slidably moved in the vertical direction, the opening aligns with and releases the latch, thereby causing the door panel to swing open; when the door panel is in the open position, the occupancy indicator releases and does not provide a visual indication that the door panel is in the closed position.

One or more aspects discussed herein can be embodied in computer-usable or readable data and/or computer-executable instructions, such as in one or more program modules, executed by one or more computers or other devices as described herein. Generally, program modules include routines, programs, objects, components, data structures, and the like that perform particular tasks or implement particular abstract data types when executed by a processor in a computer or other device. The modules can be written in a source code programming language that is subsequently compiled or interpreted for execution and/or be written in a markup (or otherwise human-readable) language such as (but not limited to) HTML and XML. The computer executable instructions can be stored on a computer readable medium such as a hard disk, optical disk, removable storage media, solid-state memory, RAM, and the like. As will be appreciated by one of skill in the art, the functionality of the program modules can be combined or distributed as desired in various embodiments. In addition, the functionality can be embodied, in whole or in part, in firmware or hardware equivalents such as integrated circuits, field programmable gate arrays (FPGA), and the like. Particular data structures can be used to implement one or more aspects discussed herein, and such data structures are contemplated within the scope of computer executable instructions and computer-usable data described herein. Various aspects discussed herein can be embodied as a method, a computing device, a system, and/or a computer program product.

Although the present invention has been described in certain specific aspects, many additional modifications and variations would be apparent to those skilled in the art. In particular, any of the various processes described herein can be performed in alternative sequences and/or in parallel (on different computing devices) in order to achieve similar results in a manner that is more appropriate to the requirements of a specific application. It is therefore to be understood that the present invention can be practiced otherwise than specifically described without departing from the scope and spirit of the present invention. Thus, embodiments of the present invention should be considered in all respects as illustrative and not restrictive. It can be evident to the annotator skilled in the art to freely combine several or all of the embodiments discussed here as deemed suitable for a specific application of the invention. Throughout this disclosure, terms like “advantageous,” “exemplary” or “preferred” indicate elements or dimensions which are particularly suitable (but not essential) to the invention or an embodiment thereof, and can be modified wherever deemed suitable by the skilled annotator, except where expressly required. Accordingly, the scope of the invention should be determined not by the embodiments illustrated, but by the appended claims and their equivalents.

What is claimed is:

1. A device for opening of a door panel, the device comprising:
a bracket mounted to a door frame;
a rail slidably mounted to the bracket that slides along the bracket in a vertical direction; and
a latch mounted on the door panel, the latch biased towards the door frame, wherein based on the door panel being in a closed position, the latch engages and is held in place by a notch in the rail, wherein based on the rail being slidably moved in the vertical direction, an opening on the rail adjacent the notch aligns with and releases the latch, thereby causing the door panel to swing open toward an open position.

2. The device of claim 1 further comprising a release actuator connected to the rail to slidably move the rail in the vertical direction.

3. The device of claim 2, wherein the release actuator is one of a motion sensor or a push button.

4. The device of claim 2, wherein the release actuator electromechanically slides and moves the rail in the vertical direction.

5. The device of claim 2, wherein the release actuator includes a foot pedal attached to the rail, wherein based on a user lifting up on the foot pedal, the rail is slidably moved in the vertical direction.

6. The device of claim 1, wherein the opening on the rail is below the notch.

7. The device of claim 1, wherein the rail includes a plurality of rail portions comprising a first rail portion and a second rail portion that includes the notch, and wherein at least a portion of the second rail portion is constructed of a relatively more durable material than the first rail portion.

8. The device of claim 1, wherein the rail mounted to the bracket defines a vertical channel between the rail and the bracket.

9. The device of claim 1, wherein the door frame includes a pilaster and the bracket is mounted to the pilaster of the door frame.

10. The device of claim 1, wherein a magnet provides a biasing force against the door panel toward the open position based on the latch being released from the notch in the rail.

11. The device of claim 1 further comprising a wireless communication module electrically connected to a sensor on the door panel, wherein the wireless communication module transmits a current status of the door panel.

12. The device of claim 1 further comprising an occupancy indicator that provides a visual indication that the door panel is in the closed position.

13. The device of claim 12, wherein the occupancy indicator is wedge-shaped and includes an exterior portion and an interior portion opposite the exterior portion,
wherein based on the door panel being in the open position, the exterior portion is flush with an exterior of the bracket and the interior portion extends from an interior of the bracket,
wherein based on the door panel being moved to the closed position, the door panel pushes against the interior portion of the occupancy indicator, thereby pivotably rotating the occupancy indicator such that the exterior portion moves from flush with the exterior of the bracket to extending from the exterior of the bracket and providing the visual indication that the door panel is in the closed position.

14. The device of claim 12, wherein the occupancy indicator includes a kicker spring that is biased to push the door panel toward the open position based on the latch being released from the notch in the rail.

15. The device of claim 12, wherein the occupancy indicator includes at least one of a red light and a green light to provide the visual indication that the door panel is in the closed position.

16. A kit for retro-fit installation for door opening on a door panel, the kit comprising:
a bracket configured to be mounted to a door frame adjacent a door panel;
a rail configured to be slidably mounted to the bracket and configured to slide along the bracket in a vertical direction, the rail including a catch assembly located within the rail, the catch assembly including a notch and an opening aligned adjacent the notch on the rail;
a latch configured to be mounted on the door panel, the latch including a bolt biased towards the notch and is configured to engage with and be held in place by the notch on the catch assembly based on the door panel being in a closed position; and
a release actuator connected to the rail and configured to slidably move the rail in the vertical direction, wherein the release actuator includes a foot pedal attached to a bottom portion of the rail and configured to slidably move the rail in the vertical direction based on a user lifting up on the foot pedal thereby causing the opening in the catch assembly to align with and release the bolt to allow the door panel to swing open and move toward an open position.

17. The kit of claim 16, wherein the opening on the rail is below the notch.

18. The kit of claim 16, wherein the rail includes a plurality of rail portions comprising a first rail portion and a second rail portion that includes the notch, and wherein at least a portion of the second rail portion is constructed of a relatively more durable material than the first rail portion.

19. The kit of claim 16, wherein the rail is configured to define a vertical channel between the rail and the bracket based on the rail being mounted to the bracket.

20. The kit of claim 16, wherein the door frame includes a pilaster and the bracket is configured to be mounted to the pilaster of the door frame.

21. The kit of claim 16 further comprising a magnet configured to provide a biasing force against the door panel toward the open position based on the latch being released from the notch in the rail.

22. The kit of claim 16, wherein the bolt is a spring-loaded bolt.

23. The kit of claim 16 further comprising a wireless communication module configured to be electrically connected to a sensor on the door panel, wherein the wireless communication module is configured to transmit a current status of the door panel.

24. The kit of claim 16 further comprising an occupancy indicator that provides a visual indication that the door panel is in the closed position.

25. The kit of claim 24, wherein the occupancy indicator is wedge-shaped and includes an exterior portion and an interior portion opposite the exterior portion,
wherein based on the door panel being in the open position, the exterior portion is flush with an exterior of the bracket and the interior portion extends from an interior of the bracket,
wherein based on the door panel being moved to the closed position, the door panel pushes against the interior portion of the occupancy indicator, thereby pivotably rotating the occupancy indicator such that the exterior portion moves from flush with the exterior of the bracket to extending from the exterior of the bracket and providing the visual indication that the door panel is in the closed position.

26. The kit of claim 24, wherein the occupancy indicator includes a kicker spring that is biased to push the door panel toward the open position based on the latch being released from the notch in the rail.

27. The kit of claim 24, wherein the occupancy indicator includes at least one of a red light and a green light to provide the visual indication that the door panel is in the closed position.
